(19) United States
(12) Patent Application Publication
(10) Pub. No.: US 2003/0200385 A1
(43) Pub. Date: Oct. 23, 2003

(54) Method and system for increasing disk drive performance

(76) Inventor: Roger Kenneth Abrams, Raleigh, NC (US)

Correspondence Address: SAWYER LAW GROUP, P.O. Box 51418, Palo Alto, CA, 94303, US

(21) Appl. No.: 10/125,707

(22) Filed: Apr. 18, 2002

(51) Int. Cl. G06F 12/00

(52) U.S. Cl. 711/113; 711/103

(57) ABSTRACT

A method and apparatus for increasing disk drive performance in a disk drive system are described. Embodiments of the present invention provide a method including the steps of providing a disk drive and a nonvolatile memory (NVM) as an integral part of the disk drive. Particular data can be selected and stored in the NVM. Such data can be file system or database metadata for example. According to the method and system disclosed herein, the present invention increases the speeds at which data is written and read to magnetic media. Drive performance is achieved while maintaining reliability.

### FIELD OF THE INVENTION

The present invention relates to disk drive systems, and more particularly to a method and system for increasing disk drive performance.

### BACKGROUND OF THE INVENTION

Disk drives are typically used as auxiliary memory storage units for computers. Disk drives provide a media on which data can be written, and from which data can be read for later use.

FIG. 1 is a block diagram of a conventional direct access storage device (DASD) 10. DASD 10 includes a disk drive 12 that has a rotating media 14. A disk drive controller 16 couples to the rotating media 14 to access data at the request of a file system 18. With regard to the rotating media 14, data is recorded on concentric, radially spaced data information tracks arrayed on the media surface. Heads (not shown) are driven in a path toward and away from a drive axis to read and write data to the disk.

One problem with disk drives is that they are inherently slow due to their mechanical nature. For example, while semiconductor memory may be accessed in a fraction of a microsecond, data on a disk drive requires several thousands of microseconds to access.

One conventional solution is to store critical data in a middle portion 20 of rotating media 14. The middle portion 20 is easier to get to because the head needs to travel half the length of the rotating media at most. The problem still exists because the speed of the head is limited due to its mechanical nature.

Another conventional solution is the use of caching. Very sophisticated efforts have been made in software and hardware to provide caching for the physical device to allow as much throughput, e.g., input/output (I/O) operations, as possible to be serviced without requiring access to the physical device. Caching also allows a program to write data to a disk file and continue immediately unaware that the data may not be transferred to the physical medium for a long time, perhaps minutes. This is referred to as asynchronous I/O and is critical for the performance of modem computer systems.

A problem with caching is that it is not permanent and thus not reliable if there is a power failure. Accordingly, caching does not address instances where critical data must be written to a physical medium to prevent losing such data in case power to the system is suddenly lost. When an operating system (OS) or application program has critical data to write that must be written to the physical medium, the OS/application must wait for the data to be written to the physical medium before proceeding. This is referred to as synchronous I/O. Examples of such critical data include journal files for a journaled file system, journal files for database programs, and certain file system metadata. For such files, caching may not be used to overcome the fact that access to the physical medium in a disk may be thousands of times slower than access to a location in cache memory. Hence, these critical files can become a performance bottleneck for the entire system.

Another conventional solution is the use of a nonvolatile memory (NVM) buffer. This solution is described in a paper, IBM TDB Vol. 38, No. 1, January 1995, pp. 443-444. This paper describes two main concepts. The first concept is directed to the addition of an NVM buffer to a diskless workstation, which allows file data to be protected temporarily without transfer to the server's disk. The paper describes in detail the simulations that demonstrate a significant number of the writes that can be discarded after a period of time. For example, a compiler running on a diskless workstation may write a temporary file in one phase of the compilation and in the next phase, may read it back in and delete the file. If the write/read/delete cycle takes place in the NVM cache, there is no need for any access to the file server and its rotating media with the accompanying delays. As the cached data is overlaid by later writes or deleted, the total number of required physical disk I/O operations decreases resulting in a performance increase.

The second concept from this paper is directed to the use of an NVM as a buffer in front of the disk to reduce the number of disk write accesses. The paper references a number of cache and buffer implementations. The savings come through two mechanisms. First, some data written becomes obsolete, as described above, and can be discarded without ever needing to be written to the magnetic media. Second, the data in the cache can be sorted and written out of order to minimize head motion on the disk thereby increasing performance. This is not peculiar to NVMs (although it's much safer with NVMs) as most modem hard drives contain volatile cache memory on the drive that is used for just this purpose. Simulations show that random writes can only use 7% of a disk's write throughput but with 4 meg of the NVM buffer the number can go up to 40%. Accordingly, this buffering scheme that allows data, which is quickly overwritten or which is written, read, and deleted, to never need to transfer to the magnetic media. While the paper describes a method of boosting performance, it relies on a cache memory scheme. Many disk drives have a memory cache on them to provide a performance boost.

A problem with the conventional solution is that cache memory is managed by the disk drive's firmware and is not accessible to or manageable by the OS. Because the OS does not manage the cache memory, the OS does not control what is stored in the cache memory.

Accordingly, what is needed is a method and system for increasing disk drive performance. The system and method should be able to process performance critical data reliably and at high speeds. The present invention addresses such a need.

### SUMMARY OF THE INVENTION

The present invention achieves the above needs and others with a method and system for increasing disk drive performance in a disk drive system. More particularly, embodiments of the present invention provide a method including the steps of providing a disk drive and a nonvolatile memory (NVM) as an integral part of the disk drive, where the NVM appears to the software, e.g., the operating system, as a part of the disk drive's writeable storage. Particular data can be selected and stored in the NVM by software external to the disk drive system. Such data can be file system or database metadata, for example.

According to the method and system disclosed herein, the present invention increases the speeds at which data is written and read to magnetic media. Drive performance is achieved while maintaining reliability.

### BRIEF DESCRIPTION OF THE DRAWINGS

FIG. 1 is a block diagram of a conventional direct access storage device (DASD); and

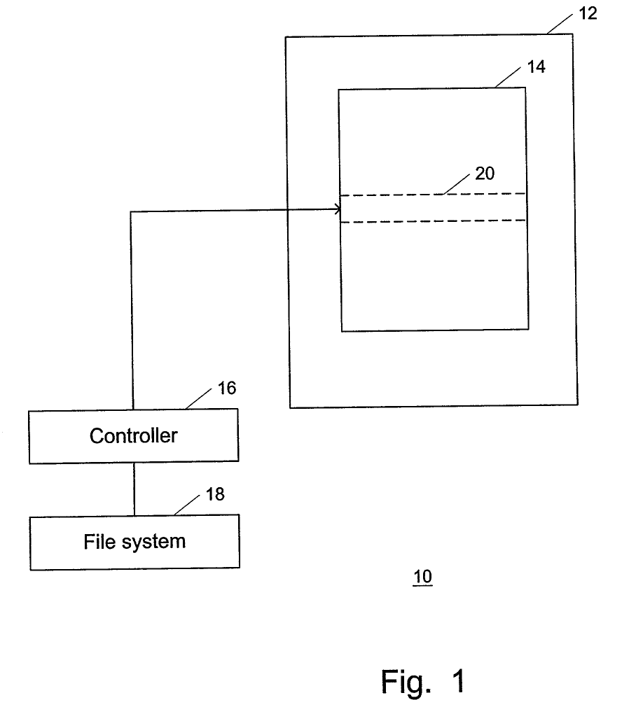

FIG. 2 is a block diagram of a DASD in accordance with the present invention.

### DETAILED DESCRIPTION

The present invention relates to disk drive systems, and more particularly to a method and system for increasing disk drive performance. The following description is presented to enable one of ordinary skill in the art to make and use the invention and is provided in the context of a patent application and its requirements. Various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

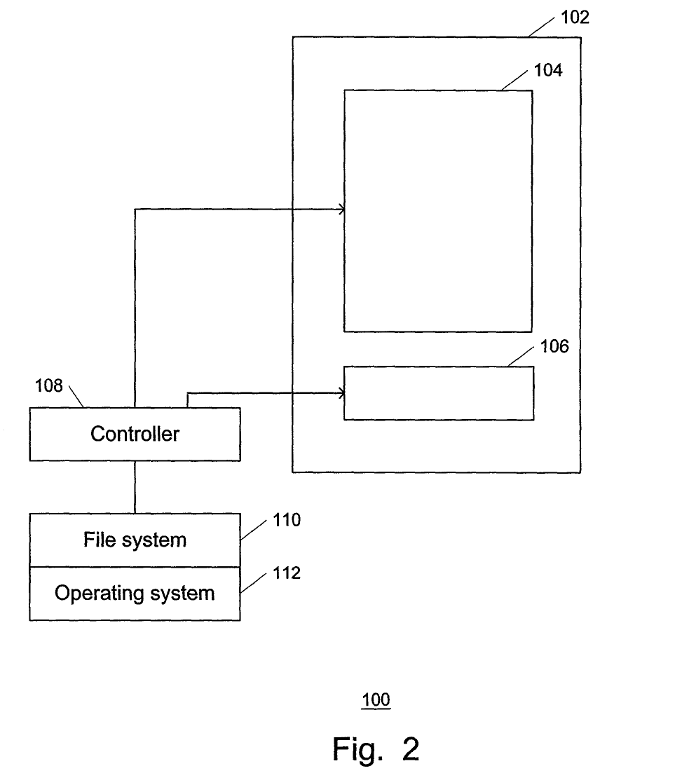

FIG. 2 is a block diagram of a DASD 100 in accordance with the present invention. The DASD 100 includes a disk drive 102 that has a rotating media 104 and a nonvolatile memory (NVM) 106. The size of the disk drive 102 can vary and will depend on the specific application. For example, the disk drive 102 can be up to 20, 40, 60, or 80 Gb, and higher. The NVM 106 is an integral part of the disk drive 102. A disk drive controller 108 couples to the rotating media 104 and to the NVM 106 to access data at the request of a file system 110. With regard to the rotating media 104, data is recorded on concentric, radially spaced data information tracks arrayed on the media surface. Heads (not shown) are driven in a path toward and away from the drive axis to read and write data to the disks.

The NVM 106 can hold data even when the power is turned off. Accordingly, the NVM 106 can be used as a memory block for permanent storage. Thus a disk drive with the integral NVM 106 according to the present invention can reliably hold performance critical data. In addition, the NVM 106 can be recognized and managed by an operating system (OS) 112 or other software. In one embodiment, the OS 112 can also divide the hard disk into multiple partitions and direct the drive's firmware to divide the NVM 106 into a multiple the partitions. In another embodiment, the NVM can be dynamically reassigned between partitions of the hard disk.

In another embodiment of the present invention, the NVM 106 can appear to the OS 112 as an integral part of the disk drive. In some embodiments, the disk drive's firmware can make it appear as if the storage in the NVM 106 was concentrated at the beginning or end of the disk. While the firmware can manage access to the NVM 106 it would not manage the contents. The software driving the disk would manage the contents. This is advantageous in that software that does not recognize the NVM 106 can still use it as though it were part of the rotating media. In another embodiment, the NVM 106 appears as a second separate logical device even though it is physically part of the hard drive. For instance, on a SCSI drive it can appear as a separate logical unit number.

When the OS 112 or other software recognizes a disk drive that implements the invention, the OS 112 or other software can set aside a memory block for performance critical files and can write those critical files into the drive memory block. The NVM 106 can be designated as such a memory block. Thus the OS 112 can store special data, e.g., file system or database metadata, in the NVM 106 instead of on the rotating media. While the data in the NVM 106 is not physically on the rotating media, the disk drive controller 108 recognizes the NVM 106 as a part of the disk drive image. This means that when the files are written, each write can be completed and be reported as successful without ever needing to wait through the delay imposed by a physical seek operation or imposed by rotational latency. Instead of a delay that can run 5,000 to 10,000 microseconds, the delay can be in the single digit microseconds. In some embodiments, the NVM 106 is physically part of the disk drive 102. Accordingly, the NVM 106 would not be separated from the disk drive 102 should the disk drive 102 be moved to another computer. Because the NVM 106 is nonvolatile, the data in it can survive power loss. The disk drives overall throughput increases since those seeks, reads, and writes that were being used to service these files can be reclaimed for other use.

More specifically, the disk drive controller 108 receives requests from the file system 110, decodes the request, and determines whether data needs to be written to or read from the rotating media 104 or the NVM 106. This process in applies to various standards such as ATA, SCSI, etc., for example.

In some embodiments, the disk drive controller 108 is preprogrammed with the disk drive information. That is, the disk drive controller 108 is programmed to recognize the NVM 106 as a special memory block. Because the access times for the NVM 106 is much faster than that of the rotating media 104, the disk drive controller 108 can store special data such as performance critical data in the NVM 106 rather than on the rotating media 104. Performance critical data can data such as file system or database metadata. Because some data is stored in the NVM 106 instead of on the rotating media 104, the number of seek, write, read, and I/O operations to the rotating media 104 is reduced.

The disk drive controller 108 informs the file system 110 of the layout of the disk drive, i.e., the size and presence of the memory blocks, how much memory is available (e.g., in the rotating media 104 and in the NVM 106), as well as the precise locations of available space, method of access, and any other information that may be useful to the file system software.

In some embodiments, the file system 110 is modified to recognize the NVM 106 as special memory. In other embodiments, if the file system 110 does not recognize the NVM 106, the file system 110 treats the NVM 106 as rotating media.

In some embodiments of the present invention, measurements or predictions about access patterns can be made to determine how to optimize the use of the memory blocks. For instance, it may be determined that certain file system metadata, such as a free space bitmap, can be placed in the NVM 106. This provides a significant performance boost. In a database system, it can be determined that certain indexes can be moved to the NVM 106 to increase performance. Such a determination can be done statically or dynamically to perform the optimization.

According to the method and system disclosed herein, the present invention provides numerous benefits. For example, it increases the speeds at which data is written and read to magnetic media. Drive performance is achieved while maintaining reliability.

Embodiments of the present invention also allow for measurements or predictions about access patterns to be done to determine how to optimize the use of the memory blocks.

Embodiments of the present invention also reduce the number of seek, write, read, and I/O operations to the rotating media.

Although the present invention has been described in accordance with the embodiments shown, one of ordinary skill in the art will readily recognize that there can be variations to the embodiments and those variations would be within the spirit and scope of the present invention. Accordingly, many modifications may be made by one of ordinary skill in the art without departing from the spirit and scope of the appended claims.

What is claimed is:

1. A method for increasing performance in a direct access storage device (DASD) system, the method comprising the steps of:
(a) providing a disk drive;
(b) providing a nonvolatile memory (NVM) as an integral part of the disk drive;
(c) selecting performance critical data to be stored in the NVM; and
(d) storing the performance critical data in the NVM to improve the performance of the DASD system.

2. The method of claim 1 wherein the performance critical data is file system metadata.

3. The method of claim 1 wherein the performance critical data is database metadata.

4. The method of claim 1 wherein an operating system recognizes the NVM as an integral part of the available storage of the disk drive.

5. A computer-readable medium including a program for increasing performance in a direct access storage device (DASD) system, the DASD system having a disk drive and a nonvolatile memory (NVM) as an integral part of the disk drive, the programing comprising instructions for:
recognizing the presence of the NVM;
selecting data to be stored in the NVM; and
storing data in the NVM.

6. The computer-readable medium of claim 5 wherein the data to be stored in the NVM is performance critical.

7. The computer-readable medium of claim 5 further comprising instructions for programming a disk drive controller to recognize the presence of the NVM.

8. The computer-readable medium of claim 5 further comprising instructions for programming a file system to recognize the presence of the NVM.

9. A system for increasing performance in a direct access storage device (DASD) system, the system comprising:
a disk drive;
a nonvolatile memory (NVM) as an integral part of the disk drive; and
a disk drive controller programmed to recognize the NVM an integral part of the disk drive, wherein the disk drive controller selects performance critical data to be stored in the NVM and stores the performance critical data in the NVM to improve the performance of the DASD system

10. The system of claim 9 wherein the NVM is used for permanent storage.

11. The system of claim 9 wherein the NVM is recognized and managed by an operating system.

12. The system of claim 9 wherein the performance critical data is file system metadata.

13. The method of claim 9 wherein the performance critical data is database metadata.

14. The method of claim 9 further comprising a file system programmed to recognize the NVM as an integral part of the disk drive, wherein the file system sends requests to the controller, and wherein the disk drive controller informs the file system of the layout of the disk drive.
